(19) United States
(12) Patent Application Publication
(10) Pub. No.: US 2026/0131691 A1
(43) Pub. Date: May 14, 2026

(54) Energy Pack Storage and Dispensing System

(71) Applicants: SHEENA Timothy, Thousand Oaks, CA (US); Ernst Karl WERNER, Anderson, IN (US)

(72) Inventors: SHEENA Timothy, Thousand Oaks, CA (US); Ernst Karl WERNER, Anderson, IN (US)

(21) Appl. No.: 19/118,142

(22) PCT Filed: Oct. 9, 2023
(86) PCT No.: PCT/US2023/076339

§ 371 Date: Apr. 3, 2025

Related U.S. Application Data
(60) Provisional application No. 63/414,244, filed on Oct. 7, 2022.

(51) Int. Cl. B60L 53/80; B60L 53/35; B60L 58/16; H01M 50/251

(52) U.S. Cl. CPC B60L 53/80; B60L 53/35; B60L 58/16; H01M 50/251

(57) ABSTRACT

An energy storage and dispensing system includes at least one rechargeable energy pack and a rail system associated with the energy pack. The rail system has at least one rail providing electricity to charge the rechargeable energy pack. A plurality of trays accommodate a respective one of the rechargeable energy packs and ride on one or more rails of the rail system. In one advantageous form, the rail system has one or two horizontal rails extending parallel to the ground and one or two vertical rails that extend perpendicular to the horizontal rails.

### FIELD OF THE INVENTION

The invention relates to an energy or power source storage system and in particular one which includes a combination of energy storage and dispensing system.

### BACKGROUND OF THE INVENTION

The world is ever evolving in terms of energy sources and storage of energy for power use on demand. Many devices including vehicles once powered by fossil fuels are now increasingly being powered by alternate energy sources including electric batteries, fuel cells, etc.

A recent development includes energy sources packaged together in discrete storage devices sometimes referred to generically as energy packs, energy packages or fuel cells. Often, devices such as vehicles may have one or more of these discrete packages together, onboard, to provide the device with both extended power, duration and range.

One limitation of current energy packs are that they require replenishing the energy source by recharging the packs disposed in the device or replenishing the energy when the energy pack is a fuel cell while located in the device. Even the fastest means for recharge, or replenishing the energy source is time consuming.

Disadvantages with current energy pack technology such as charging stations or even supercharging (e.g. rapid charging) stations, is that even fast charging is relatively slow and inefficient.

A recent advancement alternative energy storage technology are swappable energy packs in which a spent energy pack is removed from a device such as a vehicle and a fully charged replenished energy pack is inserted in its place. This is an example of a system that is an alternative to charging power or cells in place (e.g. while connected to a vehicle). The advantage of such a system is that it allows for very quick refueling or reenergizing a device (e.g. vehicle) rather than charging or replenishing the spent energy pack in place in the device e.g. vehicle. However, with current swapping technologies there are limitations in terms of capacity in terms of deployment and established design limitations limit its ability to effectively accommodate all the needed users in the future as demand increases for alternative fuel devices.

An additional disadvantage with such energy swapping systems is that they only distribute spent and replenished energy packs. As a result these systems require a large geographic footprint or area for the charging stations. Examples of such a charging stations are commercially available from the following companies, AMPLE, NIO and Better Place, their battery swapping technology herein incorporated by reference by company name. A few of their non-limiting examples are AMPLE (US 2016/368464, US 2016/137093, and U.S. Pat. No. 9,315,113), NIO (U.S. Pat. Nos. 10,144,307; 10,160,344; 10,594,154; WO 2018184309A1, CN210212346U and CN201920548676U) and Better Place (WO2013144948 and WO2013144951), all herein incorporated by reference.

As the introduction of an electrical revolution across the transport and mobility industries gains strength, maintaining a healthy on demand electrical current to all needing consumers presents a unique challenge. The addition of the electric vehicles (EV) creates higher demands to install high voltage usage points for early and current recharging infrastructures, which develops a greater consumption rate than the grid's electrical supply can support. Requiring an increase of energy storage alternatives such as battery energy storage systems (BESS), or virtual power plants (VPP). There are a number of additional disadvantages of current systems.

One disadvantage is that EV cabled charging and supercharging terminals are manual connections, requiring physical human contact with high voltage cables to recharge vehicles. Safety from the elements while connecting cables forces users to brave the elements while handling high voltage plugs often creates concerns for safety from electrocution.

Other devices such as battery pack swap stations are designed for a single unique configuration or modular sized battery packs to EVs, which require OEMs adaption to other proprietary battery packs and technology. The stations are equipped with fixed rack storage arrangements for recharging and maintenance. Multiple tracked robotics perform multiple directional movements to facilitate alignment, extraction and replacement of recharged battery packs in conjunction with synchronized lifting devices capturing the vehicle's wheels to precisely position, also lifting the vehicle over the point of extraction and installation, these are slower complex systems consisting of many moving parts.

Current energy storage systems or virtual power plants (VPP) distribute energy to the grid via fixed universal packs installed onto fixed racks within a container or apparatus. Not offering methods for physical distribution of the packs. Current systems are mostly in remote locations away from the general population and require large areas to facilitate their operations. Power loss due to distance from the energy sources and destinations works directly against the benefits of such facilities.

In addition, current charging and super charging cabled and wireless solutions present a number of disadvantages and challenges which include the requirement of a large footprint or parking lot, require high voltage supplied per station. Inability to redirect energy back to the electrical grid and do not store energy to assist with peak times and/or power outages.

Prior systems also require customers to physically connect high voltage cables to vehicles. Often these stations are not adequately covered or removed from outdoor elements resulting in inadequate safety while handling these cables. Further, current charging solutions such as supercharging and other direct current fast charging (DCFC) units come with a significant cost and have inefficient means of energy usage/loss.

A number of disadvantages and challenges exist with the current battery swap facilities and systems. Typically, these systems are created by unique OEM auto and/or battery manufacturers. Robotics and mechanical parts affect the cost and complexity to building and maintain battery swapping facilities. Further, current battery swapping facilities are extremely large with relatively small capacity of KWh and not MWh, internally at a given time due to being inefficient with the system.

In addition, current energy pack storage facilities do not utilize the entire available space efficiently and are restricted to typically obscure locations not convenient for a consumer.

In summary, the state of EV recharging and/or replenishing of power is insufficient and not a viable solution for the current and future demand.

### SUMMARY OF THE INVENTION

The present invention relates to an energy storage and dispensing system. In one of its preferable forms, the energy storage and dispensing system has a modular construction formed from a number of discrete unit, modules or apparatus that can be disposed either above or below ground. Each of the modules or apparatus work together and are connectable to provide a complete energy storage and dispensing system. In the complete system, the individual units or modules are connected to one another using a modifiable rail system that incorporates each module or apparatus as an electro-mechanical rail autonomous carts (EMRACs). These EMRACs are designated mobile nesting trays specifically adapted for storing and transporting rechargeable energy packs. Each EMRAC creates a circuit once the rail system connects to a direct energy supply. This allows energy to be dispensed into each energy pack present in a respective nesting tray and gives the ability to dispense energy back to the electrical grid as needed or desired.

The present rail system and EMRACs advantageously are integrated together using software and hardware optimized for energy pack storage maintenance. The present system is also advantageously equipped to accommodate energy pack exchanges between the present energy storage and dispensing system with an applicable device such as an electrical vehicle (EV) by including various mechanisms by which the EMRACs dispense fully powered (charged) energy packs in exchange for depleted or spent energy packs, for example from EVs or other energy pack powered vehicles/machines.

The energy packs are preferably high capacity and are stored individually in or on the EMRACs (e.g. in nesting trays) while riding/gliding along the rails system forming modules, engineered to provide maximum MWh capacity deployed in a small footprint. The small footprint is realized due to the present unique rail system in which the EMRACs ride/glide along rails parallel to the ground or in a horizontal direction that are then connected to vertical rails allowing the EMRACs to be stacked vertically above or below ground in a three-dimensional array. In the simplest form, the EMRACs would be stacked on top of each other in the 2 axis/direction, in a single stack array. However, arrays extending both in the x and y axis/direction allow for the EMRACs to be stacked side by side e.g. an array of 2×n where 2 represents the number of columns of EMRACs in the horizontal or y direction and n is the number of EMRACs stacked in the vertical direction.

Electricity to the present system is provided as integrated direct energy that recharges or redirects energy to and from the electrical grid to the multiple energy packs, inverting energy back to the grid using available Battery Management System (BMS) which monitors the state of charge (SOC) and state of health (SOH) of the energy storage and dispensing system.

The present dispensing system accommodates a variety of floor and wall mount battery pack configurations. Further, the energy pack distribution allows for rapid replacement of energy packs from electrical vehicles using available replacement/swap/exchange systems known in the art, while serving as virtual power plants (VPP) to dispense energy to homes, buildings and nearby communities and the electrical grid.

The present system also offers an opportunity to efficiently manage long-term use and re-use of energy storage devices. This includes raw materials including minerals used in the manufacture of battery cells, allowing future battery energy storage, for example an EV manufacturer to easily control and manage the life cycle including recycling and repurposing battery packs for their future uses.

Advantages of the present system include being able to reconfigure and adopt existing and possible future vehicle refueling and charging infrastructure with minimal instruction. For example, having the EMRACs array being above ground minimizes a need to excavate and construct underground infrastructure. Further, the horizontal rails in one advantageous form can be disposed on ground and therefore not require construction for embedding underground or within foundation.

The present invention, in one form thereof, is directed to an energy storage and dispensing system. The system has at least one rechargeable energy pack and a rail system associated with the energy pack. The rail system has at least one rail providing electricity to charge the rechargeable energy pack. A plurality of trays, each tray for holding a respective one of the rechargeable energy packs, rides on one or more of the rails of the rail system.

In one advantageous form, the plurality trays provide electrical connection between the rail and the rechargeable energy pack. In alternative further embodiments, the plurality of trays are vertically stackable including vertically stackable underground and/or above ground.

In one specific further alternative embodiment, the rail system comprises one or two horizontal rails extending parallel to the ground and one or two vertical rails that extend perpendicular to the horizontal rails.

The present invention in another form thereof is directed to an energy storage and dispensing system having a plurality of rechargeable energy packs and a rail system. The rail system has one or two horizontal rails extending parallel to the ground and one or two vertical rails that extend perpendicular to the horizontal rails. At least one of the horizontal rails and the vertical rails provide electricity to charge the plurality of rechargeable energy packs associated with the respective rail. The plurality of trays, each one holding a respective one of the rechargeable energy packs wide on the rails of the rail system. The plurality of trays are vertically stackable.

Advantages of the present system over prior systems, namely battery swapping systems, will be apparent from this disclosure as this system overcomes limitations of prior systems by:
1. more efficiently utilizing storage/charging space for energy packs,
2. reducing deployment footprint (e.g. parking lots) with a relatively more compact system that significantly decreases the space needed, allowing for more energy storage/usage,
3. options for both above and below ground (i.e. stacked) energy packs in storage and charging,
4. simplified system for moving, storing and charging energy packs,
5. avoids costly and inefficient in means of energy usage/loss of current supercharging (i.e. “fast” charging systems).

### BRIEF DESCRIPTION OF THE DRAWINGS

FIG. 1 is an energy storage and dispensing system in accordance with the present invention.

FIG. 2 is another energy storage and dispensing system in accordance with another aspect of the present invention.

FIG. 3 is a detailed view of a portion the energy storage and dispensing system of FIG. 1.

FIG. 4 is an enlargement of a portion of FIG. 3.

FIG. 5 is a portion of the rail system and a view into a compartment within the body of an EMRAC on the rail system in accordance with the present invention.

FIG. 6 is an enlargement of a portion of FIG. 5.

FIG. 7A is another view of a portion of the present rail system with the EMRAC's CPTR over the rails shown along with EMRAC inner workings in accordance with the present invention.

FIG. 7B is another view of a portion of the present rail system in accordance with the present invention

FIGS. 8A-8D are a series of schematic views showing an exemplar process of operation of an energy storage and dispensing system in accordance with the present invention.

FIG. 9 is an energy storage and dispensing system in accordance with another aspect of the present invention.

### DETAILED DESCRIPTION

The present disclosure is directed to an energy storage and dispensing system in which energy packs moved, stored and charged while in trays (electromagnetic-mechanical rail autonomous carts (EMRACs) using a unique rail system. The rail system includes two main components. A first component are rails disposed horizontally along the ground and vertical rails, perpendicular to the rails along the ground allowing for the EMRACs to be moved laterally or parallel to the ground and then vertically to be stacked in vertical columns of energy packs. As a result, the rail system with EMRACs accommodate the removal of a depleted energy pack from a compatible vehicle (e.g. an EV) or device, replacement the depleted energy pack with a charged energy pack and charging the depleted energy pack in the EMRACs using a system having a small footprint.

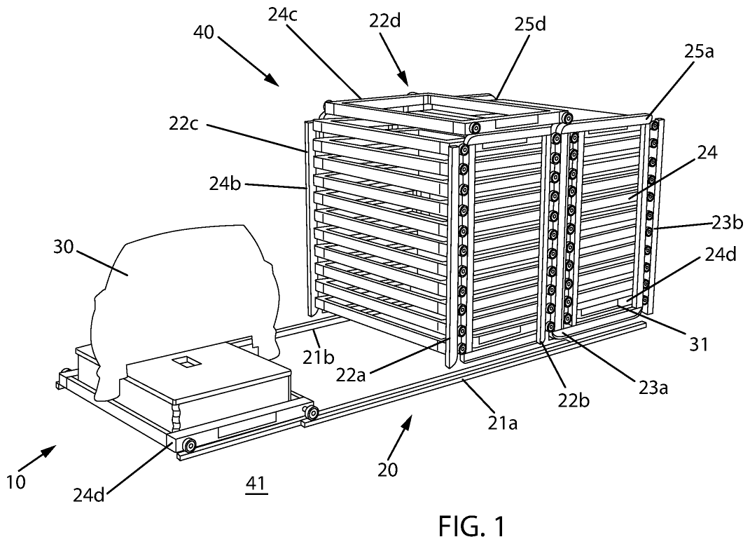

Referring to the figures and in particular to FIG. 1, energy pack storage and dispensing system 10 comprises rail system 20. Rail system 20 has a pair of rails 21a, 21b disposed horizontally along the ground. In addition, rail system 20 has two pairs of vertically extending rails 22a, 22b; and; 23a, 23b and two more complementary ones opposite 23a, 23b. EMRACs 24 ride along the rails of the rail system 20.

As depicted in FIG. 1, the rail system 20 with vertically extending rails 22a-22d and 23a, 23b form a two-dimensional array in which EMRAC 24 are stacked vertically, riding along rails 22a-22d, 23a, 23b in the vertical direction and 21a, 21b in the horizontal direction. In addition, at the top of the rail system 20, are an additional pair of rails 25 a, 25 b allowing EMRACs 24 such as 24c to more laterally or in a horizontal direction between the two vertical stacks of EMRACs 24.

The system 10 allows for the movement of an EMRAC 24 with a depleted energy pack such as EMRACs 24d from an EV 30 to and from the dispensing system and EMRAC 24d back to a vehicle 30 with a changed replacement energy pack.

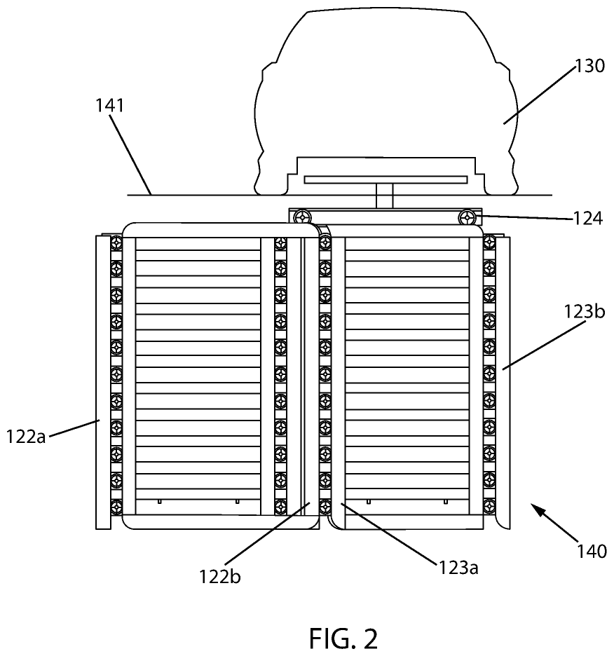

FIG. 1 has the dispensing system 40 disposed above ground 41 and FIG. 2 shows the dispensing system 40 below ground 41. Like elements in FIG. 2 to those in FIG. 1 are increased by 100 and only further described with aspects which differ from those like elements of FIG. 1.

The rail system 20 provides a path, structure and electrical connectivity or energy for recharging energy packs disposed in or on the EMRAC 24, acting as a BUS bar to provide high energy voltage current from the electrical grid to the EMRAC 24. Advantageously, the rails system 20 consists of a minimum of one pair of isolated and insulated parallel or horizontal to the ground rail tracks 21a, 21b. The rails advantageously are divisible and isolated between positive charged areas and negative charged areas so an open circuit can be established by which the EMRAC 24 will close upon insertion onto the rail tracks and the rails can be configured and modifiable as desired.

Further, the rail system 20 enables the transfer of energy from the electrical grid to energy packs and back to the electrical grid regulated and forecasted with available systems used to invert energy into other energy stored systems. In addition, the rails of the rail system 20, e.g. 21a, 21b, contain a conductive material insulted from its adjacent surrounding to energize the rails.

It should be emphasized that rail system 20 can be modified and deployed in any complex method, not limited to any one configuration let alone the two configurations of FIGS. 1 and 2.

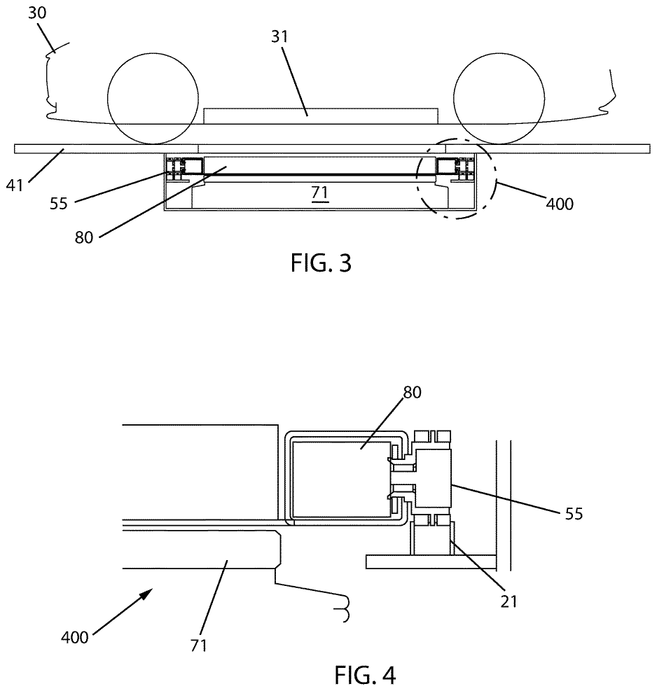

The EMRACs 24 are composed of two different assemblies; with reference being made to FIGS. 3 and 4. The first assembly is a nesting tray 50 and a contact point to rails (CPTR) 55 noting that FIG. 4 is an enlargement of area 400 of FIG. 3.

Referring specifically to FIG. 3, nesting tray 50 of EMRAC 24 is empty with vehicle 30 having a depleted EV energy pack 31 currently disposed within vehicle 30 and parked on ground 41.

FIG. 4 shows an enlargement of a drive motor 80 for the EMRAC 24. The drive motor 80 has contact point to rails (CPTR) 55 on EMRAC 24 of rail 21. A conventional battery swapping system shown schematically as system 71, can be used with system 10 including those discussed in the Background of the Invention section.

The nesting tray 50 is an opening of an EMRAC 24 which holds and accepts appropriate energy packs. The nesting tray 50 has space for motors to mobilize the contact points to the rails, hardware and software necessary for autonomous control used for activation, deployment and maintenance while providing an interface to the dispensing module 40 for charging systems of depleted energy packs and to manage and broadcast the state of health of each energy pack.

The CPTR 55 refers to apparatus and components capable of self-propulsion and allows for movement along the rails while constantly creating a conductive electrical current. This includes but is not limited to following examples:
a) wheel & axle assembly, pad & slide assembly, mechanical or magnetic gears, cogs, and etc.,
b) each contains conductive materials to receive power from the rail system,
c) contact points on EMRAC: ride along the positive and negative rails, also each CPTR 55 must be substantial enough to support the weight of fully functioning EMRACs while carrying fully charged energy packs, and
d) conducts high voltage current from the rail system, diverting energy to the required components on and within an EMRAC 24.

Energy can be directed to where componentry awaiting will begin to provide controls of movements, maintenance, communications to monitoring and human interface but mostly to charge the energy pack onboard. Charging to the packs can be a direct connection but is not limited to including induction charging adapted to system 10.

Optional configurations have attached lifting mechanisms incorporated into or underneath the nesting tray to perform within specific requirements.

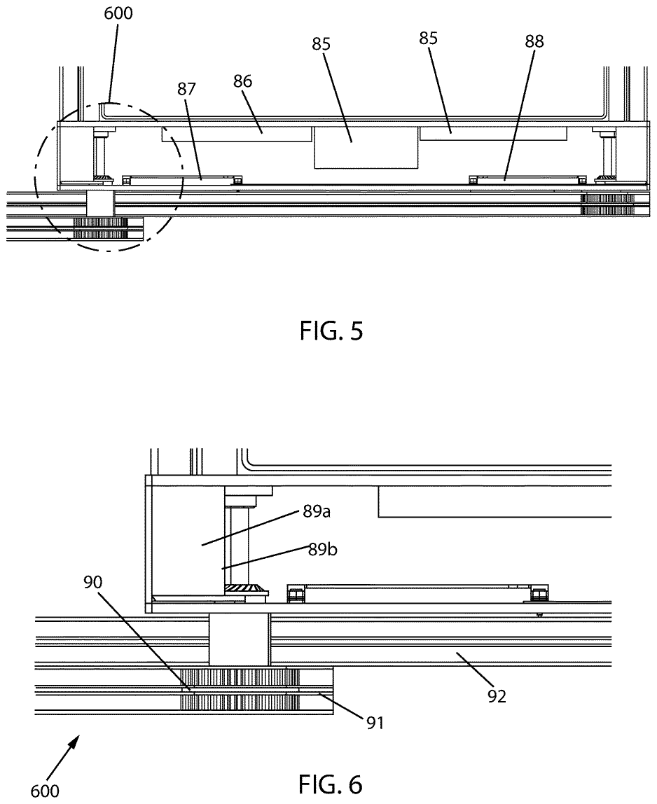

Referring now to FIG. 5 along with FIG. 6, which is an enlargement of area 600 of FIG. 5, battery and charging management systems 85 includes motherboard/power control 86, positive hard connection BUS bar 87 to the EMRAC and negative hard connection BUS bar 88 to EMRAC 24.

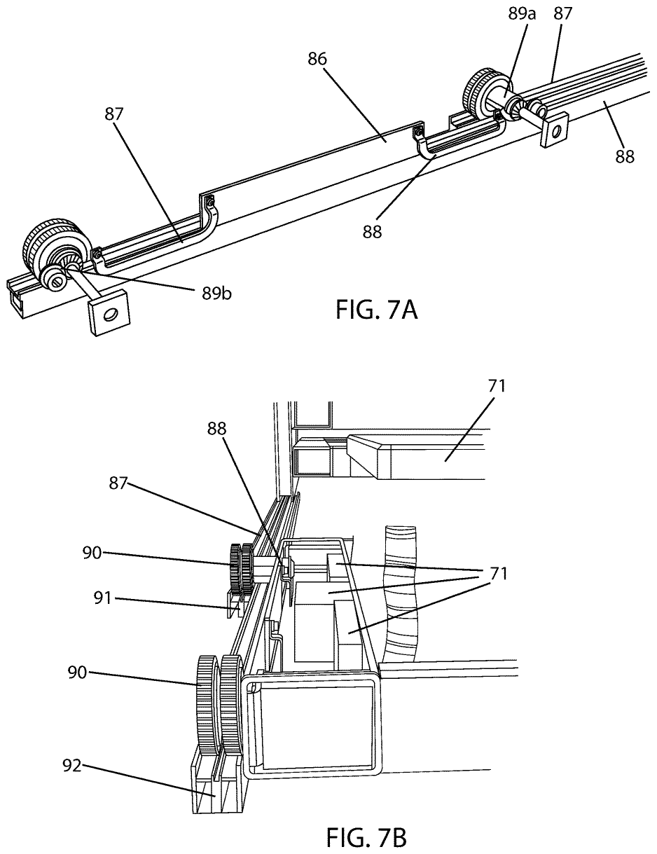

Drive motor 89a and gears 89b provide for movement of the EMRAC 24. Conductive material 90 on CPTR 55 provide for transfer of energy to and from the EMRACs 24 positive conductive strip 91 and negative conductive strips 92 are located along the rails of rails system 20 to each CPTR 55 of each EMRAC 24. FIG. 7A and FIG. 7B are additional views to those of FIG. 6.

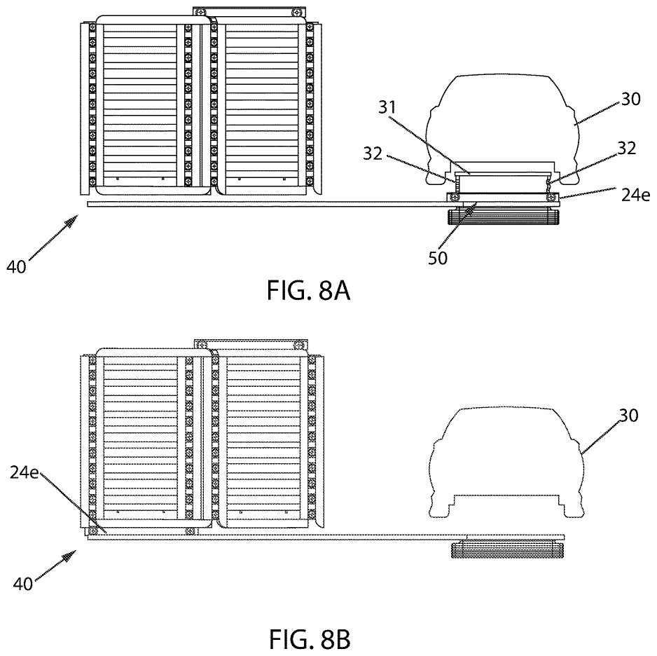

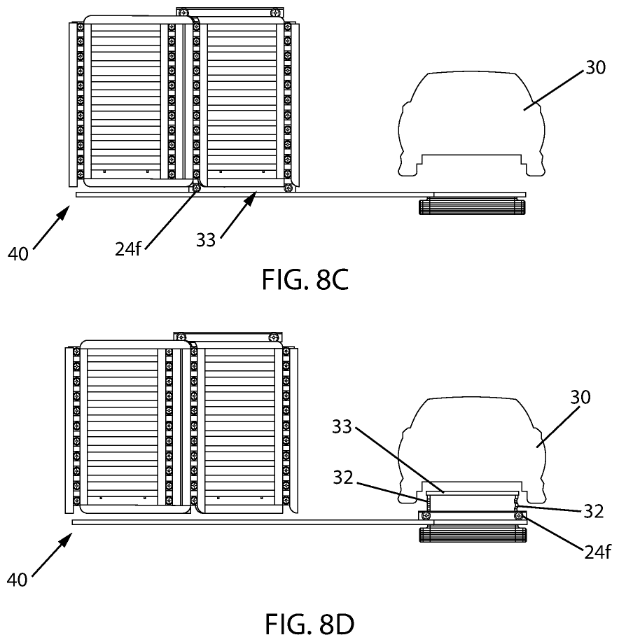

Reference is now made to FIGS. 8A-8D which are a series of figures depicting an exemplary operation of system 10. Referring to FIG. 8A, an oncoming vehicle 30 has a vacant EMRAC in a waiting position below vehicle 30. Communication is made between an EMRAC nesting tray 50 and vehicle 30. Vehicle 30 is guided to the point of exchange, precision is achieved by automating the vehicle 30 movements for pinpoint alignment, small fore and aft movements of vehicle 30 to the cross car movement of the awaiting EMRAC 24e creates satisfactory precision for the extraction of the vehicle 30 depleted battery pack/energy pack 31 to commence.

Vehicle 30 is confirmed in position and alerts the EMRAC 24e to accept the depleted energy pack 31. A lifting device (not shown) located beneath the awaiting EMRAC 24e receives a signal to lift to a specific point of contact with the depleted battery in the vehicle 30 (shown movement of depleted battery by broken lines 32). Signals are given when the lift is in position. Locks securing the depleted energy pack 31 to the vehicle 30 are then signaled to release the energy pack securely to a lift device (not shown). Signals are then given to the lift device and the depleted energy pack is lowered directly into the awaiting EMRAC 24e nesting tray which connects to an attached management system which controls the health of each attached energy pack and starts a maintenance protocol prior to controlling speeds to safely charge the depleted energy pack.

Referring to FIG. 8B, the EMRAC 24e returns the depleted energy pack 31 disposed in the nesting trays to the dispenser system 40 in a secured position therein.

### Dispenser Cycles Over One Position

Referring to FIG. 8C, signals are given once in position and all EMRACs 24 in dispenser system 40 cycle one position forward (e.g. clockwise), advancing EMRAC 24f which contains a charged energy pack 33 as a battery replacement for the vehicle 30.

Referring now to FIG. 8D, Finally, a EMRAC 24f returns charged energy pack 33 to the vehicle 30 now disposed below vehicle 30. With the EMRAC 24f now positioned beneath the vehicle 30, signals are then given to the lift device beneath the EMRAC 24f again to lift the charged energy pack from the EMRAC 24f into the vehicle 30 as shown by broken lines 32. Signals are then given once the energy pack is located within the vehicle 30, locks the energy pack to the vehicle 30 and actuate to secure the energy pack to the vehicle 30. Once completed, the vehicle 30 can exit the battery exchange area.

Possible lift devices which can be used with the present system 10 include a lift device that is capable of swapping energy packs which can be either purchased or developed separately.

Energy packs manufactured for specific use by OEMs or owners are easily accommodated by the present system.

The following is a list of benefits and advantages of the present system:

### Users Benefits

an alternative system to defeat range and recharging issues with 24-hour access to the benefits of owning or using electric transportation,
a safe hands-free environment while re-energizing vehicles with high voltage equipment shielded, out of sight and reach to users which are not required to leave the vehicle throughout the exchange process,
fast-controlled exchange of depleted UEPs, and
assuring the ownership of expensive outdated, depleted, damaged and/or dead battery packs are no longer a responsibility to the users this also allows cheaper vehicle prices and limitless battery recharging cycles instead.

### Fleet Benefits

provides abundant battery pack capacity within a small footprint real estate for depots,
allows manned and unmanned vehicles to perform duties on a 24-hr schedule, eliminating the need for excess vehicles without replaceable battery packs required to perform the same schedules,
easy installation with minimal high voltage pre-installation costs while also providing multiple configurations to fit most space requirements unlike current multiple vehicle recharging lots needing many transformers and usage points for charging devices as well as land,
simplicity of the operation of this system equates to a longer mechanical life of the dispenser, and
removes responsibility for management of spent and/or defunct UEPs and/or cells.

### Energy Provider Benefits Source/Distribution/EV Infrastructure:

offers a unique platform to distribute and manage universal energy packs (UEP),
creates organized and managed energy storage facilities available to support and assist energy for nearby communities during times of high demand or crisis,
greatly limits the number of high voltage points by combining multiple packs to recharge simultaneously within the dispenser,
frequently occupied gasoline refueling infrastructure, where thousands of vehicles refuel in one location per day are transformed into locations that accommodate the equivalent demand of battery replacement for EVs making the locations into a VPP “peaker plant” capacity for energy storage; allows EV adoption to meet these same standards which aid the growth of the many new electronic devices being added to the grid and energy storage of UEPs is the unification of which this invention foresees as a unique and more advanced infrastructure for the electric future,
the growing rate of dispensers ultimately increases energy storage capacity for the grid and combining that with the ability to dispense universal battery packs creates a considerable infrastructure opportunity for the future electric vehicles to help keep a balanced grid, and
rather than producing fixed battery pack solutions in energy storage systems and in vehicles this invention helps circulate, distribute, replace and reuse an ultimately lower total number of energy packs overall.

### For The Vehicle Manufacturers

separate the evolution of vehicles from the evolution of their energy packs,
as EVs typically outlive constantly outdated energy storage technologies, present system easily allows vehicle battery upgrades when launched by manufacturers,
the evolution of the energy storage industry creates linked systems, meaning vehicles will benefit from battery advancements and not become obsolete, and
opens new opportunities to OEMs and EV charging solutions with energy distribution to the grid using this system, offering new lines of income previously controlled by other industries for ICE vehicles which often affected overall costs for users.

### For the Energy Pack/Cell Producer

creates an opportunity to have common energy pack dimensions and requirements within other industries,
higher density battery development ultimately decreases pack sizes further making lighter weight vehicles for better efficiency which makes EV pack distribution even easier, and
creates closed loop opportunities, easing and having predetermined supply chain cycles from production, distribution, reclamation then redistribution.

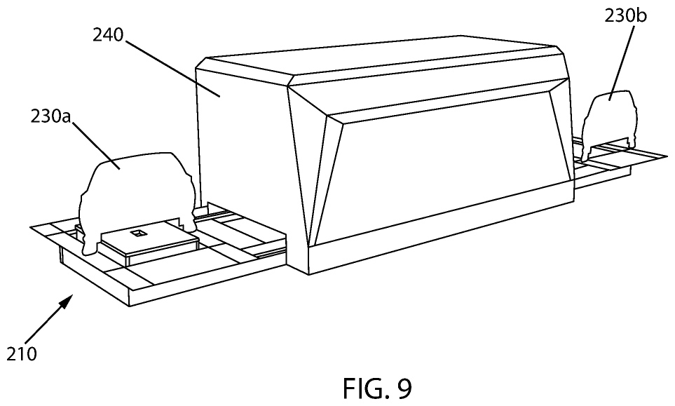

Referring now to FIG. 9, where alike elements to those of FIG. 1 are increased by 200, system 210 is an example of an above-ground dispenser system having two vehicle swapping systems, one on either side of the dispenser 240. System 210 accommodates two vehicles, vehicle 330a and 330b.

It will now be clear that the present system can be adapted in numerous manners in keeping with the spirit and scope of this disclosure which include but are not limited to above and below ground dispensing systems and different arrays and numbers of vertical and horizontal stacks of EMRACs. Further, the embodiments and examples described herein are not limited. For example, the position of the vacant battery replacing EMRAC terminal can change for other applications or different requirements. The views and figures do not limit the number of, sizes of, or capacity of battery packs in a system. Additional items and systems used in the examples may include any manufacturer BMS or swapping systems along with other necessary softwares or hardwares per application. The CPTR and rail systems can use different conductive or magnetic materials.

1. An energy storage and dispensing system, the system comprising:
at least one rechargeable energy pack;
a rail system associated with the at least one energy pack, the rail system having at least one rail providing electricity to charge the rechargeable energy pack; and
a plurality of trays, each tray for holding a respective one of the at least one rechargeable energy packs, the plurality of trays ride on one or more rails of the rail system.

2. The energy system of claim 1, wherein the plurality of trays provide electrical connection between the at least one rail and the at least one rechargeable energy pack.

3. The energy system of claim 1, wherein the plurality of trays are vertically stackable.

4. The energy system of claim 3, wherein the vertically stackable trays are disposed underground.

5. The energy system of claim 3, wherein the vertically stackable trays are disposed above ground.

6. The energy system of claim 3, wherein the vertically stackable trays are in a stack that spans underground to above ground.

7. The energy system of claim 1, wherein the rail system comprises one or two horizontally rails extending parallel the ground and one or two vertical rails that extend perpendicular to the horizontal rails.

8. An energy storage and dispensing system, the system comprising:
a plurality of rechargeable energy packs;
a rail system associated with the at least one energy pack, the rail system comprising one or two horizontally rails extending parallel the ground and one or two vertical rails that extend perpendicular to the horizontal rails; at least one of the horizontal rails and the vertical rails provide electricity to charge the plurality of rechargeable energy packs associate with the respective rail;
a plurality of trays, each tray for holding a respective one of the plurality of rechargeable energy packs, the plurality of trays ride on one or more rails of the rail system, the plurality of trays are vertically stackable.

9. The system of claim 8, wherein the plurality of trays provides electrical connection between one of the rails and the plurality of rechargeable energy packs.
